(19) United States
(12) Patent Application Publication
(10) Pub. No.: US 2021/0140598 A1
(43) Pub. Date: May 13, 2021

(54) EXTENDABLE, RETRACTABLE, ROTATABLE, DIRECTABLE RECESSED LIGHTING FIXTURE

(71) Applicant: Benjamin SALOMON, Ocean, NJ (US)

(72) Inventor: Benjamin SALOMON, Ocean, NJ (US)

(21) Appl. No.: 17/025,782

(22) Filed: Sep. 18, 2020

Related U.S. Application Data
(60) Provisional application No. 62/902,381, filed on Sep. 18, 2019.

(51) Int. Cl. F21S 8/02; F21V 21/30

(52) U.S. Cl. CPC F21S 8/028; F21S 8/026; F21V 21/30

(57) ABSTRACT

Aspects of the present disclosure describe extendable, retractable, and rotatable recessed lighting fixture.

### CROSS REFERENCE

This disclosure claims the benefit of U.S. Provisional Patent Application Ser. No. 62/902,381 filed Sep. 18, 2019, the entire contents incorporated by reference as if set forth at length herein.

### TECHNICAL FIELD

This disclosure relates generally to lighting fixtures. More particularly, it pertains to lighting fixtures that are all of extendable, retractable, rotatable, and directable that may be implemented—for example—in a recessed configuration. One or more such lighting fixtures—when combined with an automatic control system—may advantageously identify and track moving objects within their lighting field.

### BACKGROUND

As is known in the art, recessed lighting fixtures have provided designers and builders with great flexibility in design. More particularly, recessed lighting may make a room feel larger because a recessed lighting fixture takes up less visual space in the room. Because recessed lighting fixtures are set into a ceiling itself, nothing generally hangs down into the room volume to interrupt the visual space of the ceiling. Recessed lighting also makes rooms look bigger due to an effect called “wall washing”.

Notwithstanding such design and aesthetic benefits, recessed lighting may be somewhat restrictive as light patterns directed therefrom may be limited to their generally fixed nature.

### SUMMARY

An advance in the art is made according to aspects of the present disclosure directed to a recessed lighting fixture that advantageously is extendable, retractable, rotatable, and directable.

In sharp contrast to the prior art, a recessed lighting fixture according to aspects of the present disclosure advantageously permits light emitting from the fixture to be directed to a desired location. Still further, when coupled with an intelligent controller, a light fixture according to the present disclosure may be automatically controlled or configured to recognize a person and redirect itself to follow and/or anticipate that person's movement by lighting areas where that person is located or moving to.

### BRIEF DESCRIPTION OF THE DRAWING

A more complete understanding of the present disclosure may be realized by reference to the accompanying drawing in which:

FIG. 1 is a schematic exploded view diagram showing an illustrative recessed lighting fixture according to aspects of the present disclosure;

FIG. 2 is a schematic exploded view diagram showing the illustrative extendable, retractable, rotatable, and directable, recessed lighting fixture of FIG. 1 identifying additional operational elements according to aspects of the present disclosure.

FIG. 3 is a schematic diagram showing an illustrative recessed lighting fixture in retracted, extended, and directed positions relative to ceiling position according to aspects of the present disclosure;

FIG. 4 is a schematic diagram showing an illustrative recessed lighting fixture and control system communicating wirelessly that detects an individual/object (by wireless mechanism) and provides illumination for individual as that individual moves by redirecting the light and/or anticipating movement of the individual and illuminating anticipated path of the individual according to aspects of the present disclosure;

FIG. 5 is a schematic diagram showing an illustrative recessed lighting fixture relative to ceiling position according to aspects of the present disclosure;

FIG. 6 is a schematic diagram showing an alternative view of an illustrative recessed lighting fixture according to aspects of the present disclosure;

FIG. 7 is a schematic diagram showing an alternative view of an illustrative recessed lighting fixture according to aspects of the present disclosure;

FIG. 8 is a schematic diagram showing an alternative view of an illustrative recessed lighting fixture according to aspects of the present disclosure;

FIG. 9 is a schematic diagram showing an alternative view of an illustrative recessed lighting fixture according to aspects of the present disclosure;

FIG. 10 is a schematic diagram showing an alternative view of an illustrative recessed lighting fixture according to aspects of the present disclosure;

FIG. 11 is a schematic diagram showing an alternative view of an illustrative recessed lighting fixture according to aspects of the present disclosure;

FIG. 12 is a solid-view diagram showing an alternative view of an illustrative recessed lighting fixture according to aspects of the present disclosure;

FIG. 13 is a solid-view diagram showing an alternative view of an illustrative recessed lighting fixture according to aspects of the present disclosure;

FIG. 14 is a solid-view diagram showing a perspective view of an illustrative recessed lighting fixture according to aspects of the present disclosure;

FIG. 15 is a solid-view diagram showing an alternative perspective view of an illustrative recessed lighting fixture according to aspects of the present disclosure;

FIG. 16 is a solid-view diagram showing an alternative perspective view of an illustrative recessed lighting fixture according to aspects of the present disclosure;

FIG. 17 is a solid-view diagram showing a side view of an illustrative recessed lighting fixture according to aspects of the present disclosure;

FIG. 18 is a solid-view diagram showing an alternative side view of an illustrative recessed lighting fixture according to aspects of the present disclosure;

FIG. 19 is a solid-view diagram showing an alternative side view of an illustrative recessed lighting fixture according to aspects of the present disclosure;

FIG. 20 is a solid-view diagram showing an alternative side view of an illustrative recessed lighting fixture according to aspects of the present disclosure;

FIG. 21 is a solid-view diagram showing a top view of an illustrative recessed lighting fixture according to aspects of the present disclosure;

FIG. 22 is a solid-view diagram showing a bottom view of an illustrative recessed lighting fixture according to aspects of the present disclosure;

FIG. 23 is a solid-view diagram showing an alternative perspective view of an illustrative recessed lighting fixture according to aspects of the present disclosure;

FIG. 24 is a solid-view diagram showing an alternative perspective view of an illustrative recessed lighting fixture according to aspects of the present disclosure;

FIG. 25 is a solid-view diagram showing an alternative perspective view of an illustrative recessed lighting fixture according to aspects of the present disclosure;

FIG. 26 is a solid-view diagram showing an alternative perspective view of an illustrative recessed lighting fixture according to aspects of the present disclosure;

FIG. 27 is a solid-view diagram showing a perspective view of an illustrative face plate for a recessed lighting fixture according to aspects of the present disclosure;

FIG. 28 is a solid-view diagram showing an alternative perspective view of an illustrative face plate for a recessed lighting fixture according to aspects of the present disclosure;

FIG. 29 is a solid-view diagram showing a perspective view of an illustrative light body for a recessed lighting fixture according to aspects of the present disclosure;

FIG. 30 is a solid-view diagram showing an alternative perspective view of an illustrative light body for a recessed lighting fixture according to aspects of the present disclosure;

FIG. 31 is a solid-view diagram showing an alternative perspective view of an illustrative recessed lighting fixture according to aspects of the present disclosure;

FIG. 32 is a solid-view diagram showing an alternative side view of an illustrative recessed lighting fixture according to aspects of the present disclosure;

FIG. 33 is a solid-view, cut away, cross-sectional diagram showing an illustrative recessed lighting fixture according to aspects of the present disclosure;

FIG. 34 is a solid-view diagram showing an alternative side view of an illustrative recessed lighting fixture according to aspects of the present disclosure;

FIG. 35 is a solid-view diagram showing an alternative side view of an illustrative recessed lighting fixture according to aspects of the present disclosure;

FIG. 36 is a solid-view diagram showing an alternative side view of an illustrative recessed lighting fixture according to aspects of the present disclosure;

FIG. 37 is a solid-view diagram showing an alternative side view of an illustrative recessed lighting fixture according to aspects of the present disclosure; and

FIG. 38 is a solid-view diagram showing an alternative side view of an illustrative recessed lighting fixture according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

FIG. 1 is a schematic exploded view diagram showing an illustrative extendable, retractable, rotatable, and directable, recessed lighting fixture according to aspects of the present disclosure.

As may be observed from that figure the lighting fixture includes an extendible/retractable assembly including a rotatable assembly that further includes a pivotable/directable assembly. Operationally, the extendible/retractable assembly may be actuated by an individual motor that extends/retracts the assembly out/in a direction relative to the trim base plate in an axial direction. Similarly, that extendible/retractable assembly includes a rotatable assembly that may be actuated by an electric motor and rotate around that extension/retraction axis. Finally, when that assembly is extended sufficiently out from the trim base plate, a pivotable/directable assembly may be driven to direct the assembly up to perpendicular (or more) from that extension axis.

As will be understood and appreciated by those skilled in the art, such operation advantageously permits the direction of light emitted from the fixture over a full 360 degrees.

FIG. 2 is a schematic exploded view diagram showing the illustrative extendable, retractable, rotatable, and directable, recessed lighting fixture of FIG. 1 identifying additional operational elements according to aspects of the present disclosure.

Those skilled in the art will readily understand and appreciate that such a lighting fixture is typically installed in a ceiling, such that a face plate is substantially flush with that ceiling. When so installed, the elements above the face place are substantially hidden from view of a person located in a room where the fixture is installed.

With reference to that figure it may be observed that a fixed base plate assembly is mechanically coupled to a fixed face plate by one or more linear bearings and an extension lead screw. An extension drive motor operates the lead screw such that the extendible/retractable, rotatable, directable lighting assembly is moved along an axis such that it extends/retracts from/into the ceiling into which the overall assembly is located.

Similarly, a rotation drive motor is mechanically coupled to a portion of the extendible/retractable assembly and when operated, rotates that portion around the extension/retraction axis.

Finally, when the extendible/retractable assembly is sufficiently extended from the face plate, a direction/pivot drive motor may drive the pivoting/directing of the light such that it may be directed radially relative to the extension axis. As will be appreciated, such combined movements permit the light emitted from the fixture to be directed to any direction within a room in which it is installed.

FIG. 3 is a schematic diagram showing an illustrative recessed lighting fixture in retracted, extended, and directed positions relative to ceiling position according to aspects of the present disclosure.

As may be observed from that figure, when in the retracted position a recessed lighting fixture may operate and provide light in a manner similar to that of a conventional, prior art recessed lighting fixture. Of interest, lighting fixtures according to the present disclosure may include any of a variety of lighting sources known in the art, including incandescent, or light emitting diode—among others.

While not shown in great detail in the figure, the light assembly within the fixture may be rotated—even in the retracted position. When so rotated, a lens or filter or other element positioned at an output of the light—i.e., on/in/part of the ceiling trim—may change the emitted characteristics when coupled with other output aperture(s) that are part of the light.

Further, the light may be extended via extension mechanism we shall show in greater detail. When so extended, the light may still be rotated via rotation mechanism.

Finally, when in the extended position—or a limited extended position—depending upon the particular placement of the pivot point (hinge), the emitted light may be directed to nearly any area beneath the fixture within a room in which it is installed. As will be appreciated, such directed/pivoted light may serve as a wall wash, or a flood/spot in an area or floor space. Once sufficiently extended and pivoted/directed, the light may be rotated to cover any desired area where light is desired.

FIG. 4 is a schematic diagram showing an illustrative recessed lighting fixture and control system communicating wirelessly that detects an individual/object (by wireless mechanism) and provides illumination for individual as that individual moves by redirecting the light and/or anticipating movement of the individual and illuminating anticipated path of the individual according to aspects of the present disclosure.

As illustrated in that figure, one or more recessed fixtures according to aspects of the present disclosure are shown in communication with a controller via wireless mechanisms. Those skilled in the art will understand and appreciate that such communication may take place via wireless or wired or a combination of such. Those skilled in the art will further recognize that any of a number of known signaling and or higher order protocols may be employed to effect such communications.

Similarly shown in the figure, a person, shown carrying a wireless tag or other identifier allows the controller and/or the lighting fixture(s) to detect the present of the person. Of course, those skilled in the art will recognize that an alternative detection system, i.e., ultrasonic, etc., may reside in any or all of the controller/room/fixtures to detect the individual and her movement—without carrying an id or other RFID tag or personal device such as a contemporary cellular telephone or other device.

Note that in this scenario, when the individual is detected, an appropriate light may illuminate an area as necessary. As the individual moves through the area, the light(s) may advantageously detect and/or anticipate the individual's movement and provide lighting as necessary. Such flexibility is only achieved as now taught and described—by a recessed lighting fixture that is extendible/retractable/directable/rotatable.

FIG. 5 is a schematic diagram showing an illustrative recessed lighting fixture relative to ceiling position according to aspects of the present disclosure.

FIG. 6 is a schematic diagram showing an alternative view of an illustrative recessed lighting fixture according to aspects of the present disclosure.

FIG. 7 is a schematic diagram showing an alternative view of an illustrative recessed lighting fixture according to aspects of the present disclosure.

FIG. 8 is a schematic diagram showing an alternative view of an illustrative recessed lighting fixture according to aspects of the present disclosure.

FIG. 9 is a schematic diagram showing an alternative view of an illustrative recessed lighting fixture according to aspects of the present disclosure.

FIG. 10 is a schematic diagram showing an alternative view of an illustrative recessed lighting fixture according to aspects of the present disclosure.

FIG. 11 is a schematic diagram showing an alternative view of an illustrative recessed lighting fixture according to aspects of the present disclosure.

FIG. 12 is a solid-view diagram showing an alternative view of an illustrative recessed lighting fixture according to aspects of the present disclosure.

FIG. 13 is a solid-view diagram showing an alternative view of an illustrative recessed lighting fixture according to aspects of the present disclosure.

FIG. 14 is a solid-view diagram showing a perspective view of an illustrative recessed lighting fixture according to aspects of the present disclosure.

FIG. 15 is a solid-view diagram showing an alternative perspective view of an illustrative recessed lighting fixture according to aspects of the present disclosure.

FIG. 16 is a solid-view diagram showing an alternative perspective view of an illustrative recessed lighting fixture according to aspects of the present disclosure.

FIG. 17 is a solid-view diagram showing a side view of an illustrative recessed lighting fixture according to aspects of the present disclosure.

FIG. 18 is a solid-view diagram showing an alternative side view of an illustrative recessed lighting fixture according to aspects of the present disclosure.

FIG. 19 is a solid-view diagram showing an alternative side view of an illustrative recessed lighting fixture according to aspects of the present disclosure.

FIG. 20 is a solid-view diagram showing an alternative side view of an illustrative recessed lighting fixture according to aspects of the present disclosure.

FIG. 21 is a solid-view diagram showing a top view of an illustrative recessed lighting fixture according to aspects of the present disclosure.

FIG. 22 is a solid-view diagram showing a bottom view of an illustrative recessed lighting fixture according to aspects of the present disclosure.

FIG. 23 is a solid-view diagram showing an alternative perspective view of an illustrative recessed lighting fixture according to aspects of the present disclosure.

FIG. 24 is a solid-view diagram showing an alternative perspective view of an illustrative recessed lighting fixture according to aspects of the present disclosure.

FIG. 25 is a solid-view diagram showing an alternative perspective view of an illustrative recessed lighting fixture according to aspects of the present disclosure.

FIG. 26 is a solid-view diagram showing an alternative perspective view of an illustrative recessed lighting fixture according to aspects of the present disclosure.

FIG. 27 is a solid-view diagram showing a perspective view of an illustrative face plate for a recessed lighting fixture according to aspects of the present disclosure.

FIG. 28 is a solid-view diagram showing an alternative perspective view of an illustrative face plate for a recessed lighting fixture according to aspects of the present disclosure.

FIG. 29 is a solid-view diagram showing a perspective view of an illustrative light body for a recessed lighting fixture according to aspects of the present disclosure.

FIG. 30 is a solid-view diagram showing an alternative perspective view of an illustrative light body for a recessed lighting fixture according to aspects of the present disclosure.

FIG. 31 is a solid-view diagram showing an alternative perspective view of an illustrative recessed lighting fixture according to aspects of the present disclosure.

FIG. 32 is a solid-view diagram showing an alternative side view of an illustrative recessed lighting fixture according to aspects of the present disclosure.

FIG. 33 is a solid-view, cut away, cross-sectional diagram showing an illustrative recessed lighting fixture according to aspects of the present disclosure.

FIG. 34 is a solid-view diagram showing an alternative side view of an illustrative recessed lighting fixture according to aspects of the present disclosure.

FIG. 35 is a solid-view diagram showing an alternative side view of an illustrative recessed lighting fixture according to aspects of the present disclosure.

FIG. 36 is a solid-view diagram showing an alternative side view of an illustrative recessed lighting fixture according to aspects of the present disclosure.

FIG. 37 is a solid-view diagram showing an alternative side view of an illustrative recessed lighting fixture according to aspects of the present disclosure.

FIG. 38 is a solid-view diagram showing an alternative side view of an illustrative recessed lighting fixture according to aspects of the present disclosure.

While we have presented this disclosure using some specific examples, those skilled in the art will recognize that our teachings are not so limited. Accordingly, this disclosure should be only limited by the scope of the claims attached hereto.

1. A recessed lighting fixture comprising:
a lighting element configured to emit light when electrically energized;
said lighting fixture CHARACTERIZED IN THAT
the lighting element is extendible;
the lighting element is rotatable;
the lighting element is pivotable.

2. The recessed lighting fixture according to claim 1 wherein the lighting element is extendable in an axis perpendicular to a ceiling in which the fixture is installed.

3. The recessed lighting fixture according to claim 2 wherein the lighting element is rotatable about the axis perpendicular to the ceiling.

4. The recessed lighting fixture according to claim 3 wherein the lighting element is pivotable in directions to or from that perpendicular axis.

5. The recessed lighting fixture according to claim 1 wherein the lighting element is extended in response to a person entering a room in which the fixture is installed.

6. The recessed lighting fixture according to claim 5 wherein the lighting element is pivoted in response to the person in the room.

7. The recessed lighting fixture according to claim 6 wherein the lighting element is rotated in response to the person in the room.

8. The recessed lighting fixture according to claim 1 wherein the lighting element is pivoted only after being extended.
